(19) United States
(12) Patent Application Publication
(10) Pub. No.: US 2007/0031535 A1
(43) Pub. Date: Feb. 8, 2007

(54) Coated chewable confection

(76) Inventor: Mary K. Robinson, Sparta, NJ (US)

Correspondence Address: HOFFMANN & BARON, LLP, 6900 JERICHO TURNPIKE, SYOSSET, NY, 11791, US

(21) Appl. No.: 11/498,223

(22) Filed: Aug. 2, 2006

Related U.S. Application Data
(60) Provisional application No. 60/704,704, filed on Aug. 2, 2005.

(51) Int. Cl. A23G 4/18

(52) U.S. Cl. 426/5

(57) ABSTRACT

The present invention relates to coated chewable product that may provide separate and distinct textures and hardness levels in different segments of the product. More specifically, in some embodiments, the present invention provides a chewable confectionery product including: a dissolvable tablet core, which includes a first flavor; and a coating surrounding the tablet core, which includes a second flavor. The first flavor is different from the second flavor. Upon consumption, the confectionery product may provide a sequential release of the two different flavors.

### CROSS-REFERENCE TO RELATED APPLICATION

This application claims the benefit of U.S. Provisional Application No. 60/704,704, filed Aug. 2, 2005, the contents of which are incorporated herein by reference.

### FIELD

The present invention includes confectionery products that may provide separate and distinct textures and hardness levels in different segments of the product. More specifically, the products may include a dissolvable or chewy core, such as a tablet or candy core, and a hard, crunchy or soft candy coating. Each segment also may include a different flavor, thereby providing a sequential release of different flavors when orally consumed by an individual. The present invention also provides methods for preparing such confectionery products and methods of sequentially releasing flavors in the oral cavity of an individual.

### BACKGROUND

Pressed tablet confectioneries have been provided in a variety of different flavors. In some instances, dual flavors have been incorporated together into a pressed tablet core or in multiple pressed layers. Such tablets provide multiple flavors in a tablet form where the texture and mouthfeel is substantially homogenous. For example, multi-layered pressed tablets provide the perception of an overall single texture in the mouth, as well as a simultaneous release of flavors during consumption by an individual user. Prior confectionery tablets not only failed to provide multi-textured formats, but also lacked the ability to provide a sequential flavor release profile, at least a portion of which is attributable to the different compositional makeup and hardness levels.

More particularly, certain flavor profiles, such as combinations of fruit and mint flavors, may be more enjoyable to an individual user when released sequentially in the mouth. For example, an individual user may prefer experiencing a fruity taste first and, later, a breath freshening taste of a mint flavor. If released simultaneously, the individual flavors may be obscured. Currently known pressed tablet configurations, however, are not adapted to provide such a sequential flavor delivery.

Therefore, there is a need for chewable tablets that can provide separate and distinct textures and hardness levels, as well as a sequential release of different flavors. The distinct textures may impart varied sensations throughout consumption by an individual user, particularly as the chew residence time in the mouth increases, or as the user alternates between chewing and permitting slow dissolution of the product in the mouth. Moreover, the different flavors incorporated into the separate and distinct segments of the product may be complimentary, yet more enjoyably consumed when released sequentially from the product.

### SUMMARY

In some embodiments, there is provided a chewable confectionery product including: a dissolvable tablet or chewy candy core containing a first flavor; and a coating surrounding the tablet core, which contains a second flavor. The first flavor is different from the second flavor.

In some embodiments, there is provided a chewable confectionery product including: a dissolvable tablet or chewy candy core containing a first flavor, and a coating surrounding the tablet core, which contains a second flavor and a third flavor. The first flavor is different from the second flavor and third flavor.

In some embodiments, there is provided a chewable confectionery product including: a chewable candy core comprising a first flavor; and a coating surrounding the tablet core, which contains a second flavor. The first flavor is different from the second flavor.

In some embodiments, there is provided a chewable confectionery product including: a chewable candy core comprising a first flavor; and a coating surrounding the tablet core, which contains a second flavor and a third flavor. The first flavor is different from the second flavor and the third flavor.

Some embodiments provide a sequential flavor delivery system including: (a) a dissolvable pressed tablet core or a chewable candy core, the core including: (i) at least one sugarless bulk sweetener; (ii) at least one intense sweetener; (iii) a first flavor selected from fruit, cinnamon and mint flavors; and (iv) a lubricant; and (b) coating surrounding the pressed tablet core, the coating including: (i) at least one sugarless bulk sweetener; (ii) at least one intense sweetener; (iii) a coloring agent; and (iv) a second flavor selected from fruit, cinnamon and mint flavors, wherein the first flavor is different from the second flavor. The dissolvable pressed tablet core desirably has a moisture content of less than about 1%.

Some embodiments provide a confectionery composition including: a substantially water-soluble tablet or chewy candy core which contains a first flavor; and a confectionery coating substantially enrobing the core, which contains a second flavor.

Some embodiments provide a confectionery composition including: a substantially water-soluble tablet or chewy candy core which contains a first flavor; and a confectionery coating substantially enrobing the core, which contains a second flavor and a third flavor.

In some embodiments, there is provided a method of providing a sequential flavor release in the oral cavity of an individual, which includes the steps of: (a) providing a confectionery product including: (i) a dissolvable pressed tablet or chewy candy core containing a first flavor; and (ii) a coating surrounding the pressed tablet core, which contains a second flavor, wherein the first flavor is different from the second flavor; (b) applying the product into the oral cavity of the individual; (c) allowing the coating to dissolve and release the second flavor into the oral cavity of the individual; and (d) allowing the core to dissolve and release the first flavor into the oral cavity of the individual.

In some embodiments, there is provided a method of preparing a chewable confectionery product, which includes the steps of: (a) providing a particulate bulk sweetener; (b) mixing the particulate bulk sweetener with a first flavor; (c) punching or pressing the mixture to form a tablet core; and (d) applying one or more layers of a coating material onto the tablet core, wherein the coating material includes a second flavor, and wherein the first flavor is different from the second flavor.

### DETAILED DESCRIPTION

As used herein the transitional term “comprising,” (also “comprises,” etc.) which is synonymous with “including,” “containing,” or “characterized by,” is inclusive or open-ended and does not exclude additional, unrecited elements or method steps, regardless of its use in the preamble or the body of a claim.

The term “food-grade acid,” as used herein, encompasses any acid that is acceptable for use in edible compositions.

As will be described in detail herein, embodiments of the present invention relate to confectionery products that contain different flavors in different textured segments of the product. More specifically, some embodiments provide chewable confectionery products, which have at least two separate and distinct segments, i.e., a hard or soft coating, or shell, surrounding a chewable tablet or candy core. The core may be a friable, pressed tablet core having a low moisture content. The core may also be a chewy candy such as a nougat. The hard or soft coating may have a smooth surface provided by a plurality of coating solution layers. In some embodiments, the coating has a thickness sufficient to impart a crunchy coating, substantially similar to those surrounding pellet chewing gums. The hard or soft coating contains at least one different flavor from the chewable core.

The flavors in the coating and the chewable core may be different but from the same flavor category. For example, two different mint flavors, such as two different peppermint extracts or peppermint and spearmint flavors may be employed, with at least one in the chewable core and at least one in the coating. Two different fruit flavors, spicy flavors or vanilla flavors similarly may be used respectively in the coating and chewable core.

In some embodiments, the flavors in the coating and chewable core may be from different flavor categories. For example, the following different combinations may be used: a fruit flavor and a mint flavor; a fruit flavor and a vanilla flavor; a fruit flavor and a spicy flavor; a mint flavor and a vanilla flavor; a mint flavor and a spicy flavor; or a vanilla flavor and a spicy flavor. The choice of segment, i.e. coating or core, in which to incorporate the different flavors in the selected flavor combination may depend on the desired flavor release profile, i.e., which flavor is intended to be perceived initially and sequentially. Multiple flavors may be incorporated into each segment.

The chewable confectionery product may be entirely consumed, i.e., dissolvable in the mouth. This type of product therefore is distinctly different from chewing gum pellet products having a crunchy coating. The individual compositional formats, which are present in the distinct segments of the confectionery product, may contain predominant amounts of water-soluble ingredients, such as sweeteners, which carry and aid in the release of flavors and other components. The distinct segments may have different hardness levels and different density levels. These characteristics may be used to design and alter the flavor release profiles. Thus, the different compositional make-up, hardness and density levels and segment location, i.e., core versus coating, may contribute to the flavor release profile, texture and mouthfeel sensations and overall consumer experience.

Accordingly, upon consumption, the confectionery product may impart a varied mouthfeel as the individual user perceives the different textures of the product and as the coating and core textures co-mingle in the mouth. Moreover, the individual user may experience a sequential flavor profile with the flavor(s) in the coating first and, subsequently, the different flavor(s) in the core.

Chewable Confectionery Products

As mentioned above, embodiments described herein provide chewable confectionery products, which are entirely consumable. The chewable confectionery product may include at least two separate and distinct segments: a dissolvable tablet core and a coating surrounding the core. The core may contain a first flavor, while the coating contains a second and different flavor. The two flavors may be complementary or vastly different. Additional embodiments may have a third flavor in the coating which is different from the first flavor. The two flavors may be complementary or vastly different.

Other embodiments of chewable confectionery products may include a chewable candy core and a coating surrounding the core. The core may contain a first flavor, while the coating contains a second and different flavor. The two flavors may be complementary or vastly different. Additional embodiments may have a third flavor in the coating which is different from the first flavor. The two flavors may be complementary or vastly different.

In accordance with some embodiments, the core of the confectionery product may be a pressed tablet. Alternatively, in some embodiments, the core may be any other form of tablet, such as an extruded tablet, molded tablet or any combination thereof. In some embodiments, the core may be water-soluble, particularly a water-soluble pressed tablet. The moisture content of the core may vary, but may have a moisture content of 1% or less. In addition, the core may have a hardness of at least about 10 KPU. In some embodiments, the core may be about 5% to about 95% by weight of the total confectionery product. In other embodiments, the core may be about 15% to 75% by weight. In addition to the first flavor, the core may include at least one bulk sweetener, such as a sugar sweetener and/or sugarless bulk sweetener. In pressed tablet embodiments, the bulk sweetener may be in a particulate form, such as a powder.

In some embodiments, the core of the confectionery product may be a chewy candy. Suitable chewy candies can include, but are not limited to, nougats, toffees, taffies, gummies, and jellies. In addition to the first flavor, the core may include at least one bulk sweetener, such as a sugar sweetener and/or sugarless bulk sweetener.

The coating, or shell, of the confectionery product may at least substantially surround, or enrobe, the core. In some embodiments, the coating may wholly surround the core. The coating may be about 5% to about 95% by weight of the total confectionery product. In other embodiments the core may be about 25% to about 85% by weight of the total confectionery product. In addition to the second flavor, the coating of the confectionery product also may contain at least one bulk sweetener. The bulk sweetener may be a sugar sweetener and/or sugarless bulk sweetener.

In addition to the unique attributes due to different flavor release profiles in the coating and the core, the crunchiness of the coating juxtaposed with the smoother chew of the core, can provide a unique sensory experience.

In some embodiments, an individual chewable confectionery product may weigh about 0.2 g to about 6 grams (g).

As mentioned above, the core and coating of the confectionery product each may include at least one different flavor. Any combination of flavors in the coating and core may be used to provide any desired flavor profile. Upon consumption, the initial flavor impact may be the coating flavor, the core flavor or a combination of both flavors. For instance, in some embodiments, the individual user may sequentially experience the different flavors upon consumption of the product. In particular, the individual user may experience the flavor in the coating first and, as the coating dissolves, experience the different flavor in the core. In some embodiments, the individual user may experience both flavors together as they chew and consume the product. The flavors may combine in the individual user's mouth to provide an enhanced flavor perception or flavor extension of one or both of the flavors. In some embodiments, different flavors can be included in different layers of the coating. Having different flavors in different levels of the coating can create flavor experiences such as where the individual user experiences more than one flavor as the coating dissolves and experiences yet another flavor in the core. Alternatively, the various flavors in both the coating layers and core can combine upon chewing for a combinatorial experience.

Compounds that provide flavor (flavorings or flavor agents), which may be used include those flavors known to the skilled artisan, such as natural and artificial flavors. These flavorings may be chosen from synthetic flavor oils and flavoring aromatics and/or oils, oleoresins and extracts derived from plants, leaves, flowers, fruits, and so forth, and combinations thereof. Nonlimiting representative flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil. Also useful flavorings are artificial, natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, pineapple, watermelon, apricot, banana, melon, apricot, ume, cherry, raspberry, blackberry, tropical fruit, mango, mangosteen, pomegranate, papaya and so forth. Other potential flavors include a milk flavor, a butter flavor, a cheese flavor, a cream flavor, and a yogurt flavor; a vanilla flavor; tea or coffee flavors, such as a green tea flavor, a oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a chamomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bay leaf flavor, and a wasabi (Japanese horseradish) flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor. These flavoring agents may be used in liquid or solid form and may be used individually or in admixture. Commonly used flavors include mints such as peppermint, menthol, spearmint, artificial vanilla, cinnamon derivatives, and various fruit flavors, whether employed individually or in admixture. Flavors may also provide breath freshening properties, particularly the mint flavors when used in combination with cooling agents.

Other useful flavorings include aldehydes and esters such as cinnamyl acetate, cinnamaldehyde, citral diethylacetal, dihydrocarvyl acetate, eugenyl formate, p-methylamisol, and so forth may be used. Generally any flavoring or food additive such as those described in Chemicals Used in Food Processing, publication 1274, pages 63-258, by the National Academy of Sciences, may be used. This publication is incorporated herein by reference.

Further examples of aldehyde flavorings include but are not limited to acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), cherry, grape, strawberry shortcake, and mixtures thereof.

In some embodiments, the flavor may be employed in either liquid form and/or dried form. When employed in the latter form, suitable drying means such as spray drying the liquid may be used. Alternatively, the flavor may be absorbed onto water soluble materials, such as cellulose, starch, sugar, maltodextrin, gum arabic and so forth or may be encapsulated. The actual techniques for preparing such dried forms are well-known.

In some embodiments, the flavor may be used in many distinct physical forms well-known in the art to provide an initial burst of flavor and/or a prolonged sensation of flavor. Without being limited thereto, such physical forms include free forms, such as spray dried, powdered, beaded forms, encapsulated forms, and mixtures thereof.

The amount of flavor employed herein may be a matter of preference subject to such factors as the individual flavor, the carrier employed, and the strength of flavor desired. Thus, the amount of flavoring may be varied in order to obtain the result desired in the final product.

In general, the flavors are present in amounts of about 0.02% to about 15%, and more specifically from about 0.05% to about 3%, and even more specifically, from about 0.50% to about 1.8%, by weight of the product.

As discussed above, the flavors may be selected to provide any desired flavor profile. In some embodiments, the flavor in the coating or the core may be dominant as compared to the other flavor, or, in some embodiments, the flavors may equally complement one another. Some embodiments may include flavors from the same flavor category, such as two different mint flavors, to provide an extended flavor perception. In other embodiments, flavors may be selected from different flavor categories, such as a combination of fruit and mint flavors or a combination of cinnamon and mint flavors. For example, the flavor in the coating, i.e., the second flavor, may be a fruit flavor, whereas the flavor in the core, i.e., the first flavor, may be a mint flavor. Such embodiments may first deliver a fruity taste as the coating dissolves, while subsequently delivering a refreshing taste as the individual user consumes the mint-flavored core. In some embodiments, the opposite flavor profile may be employed, i.e., mint flavor in the coating and fruit flavor in the core.

The core and coating may also each contain bulk sweeteners, as mentioned above. Suitable sugar sweeteners for use in the core and/or coating generally include mono-saccharides, di-saccharides and poly-saccharides such as but not limited to, sucrose (sugar), dextrose, maltose, dextrin, xylose, ribose, glucose, mannose, galactose, fructose (levulose), lactose, invert sugar, fructo oligo saccharide syrups, partially hydrolyzed starch, corn syrup solids and mixtures thereof.

Suitable sugarless bulk sweeteners for use in the core and/or coating include sugar alcohols (or polyols) such as, but not limited to, sorbitol, xylitol, mannitol, galactitol, maltitol, hydrogenated isomaltulose (isomalt), lactitol, erythritol, hydrogenated starch hydrolysate, stevia and mixtures thereof.

Suitable hydrogenated starch hydrolysates include those disclosed in U.S. Pat. No. 4,279,931 and various hydrogenated glucose syrups and/or powders which contain sorbitol, maltitol, hydrogenated disaccharides, hydrogenated higher polysaccharides, or mixtures thereof. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydrolysates different properties. Mixtures of hydrogenated starch hydrolysates, such as LYCASIN®, a commercially available product manufactured by Roquette Freres of France, and HYSTAR®, a commercially available product manufactured by SPI Polyols, Inc. of New Castle, Del., are also useful.

In some embodiments, the confectionery product may be a sugared product. In such embodiments, the core and the coating both may contain sugar sweeteners, as provided above. The sugar sweeteners may be the same or different. In other embodiments, the confectionery product may be a sugar-free product in which the core and coating both may contain sugarless bulk sweeteners, as provided above. The sugarless bulk sweeteners may be the same or different. Other embodiments provide for a core and/or coating with a hybrid combination of sugar sweetener and a sugarless bulk sweetener. Still other embodiments may provide a hybrid product in which the core and coating contain different bulk sweeteners. For instance, the core may include a sugar sweetener and the coating a sugarless bulk sweetener or vice-versa.

In some embodiments, high-intensity sweeteners may be used. Without being limited to particular sweeteners, representative categories and examples include:

(a) water-soluble sweetening agents such as dihydrochalcones, monellin, stevia, steviosides, rebaudioside A, glycyrrhizin, dihydroflavenol, and sugar alcohols such as sorbitol, mannitol, maltitol, xylitol, erythritol and L-aminodicarboxylic acid aminoalkenoic acid ester amides, such as those disclosed in U.S. Pat. No. 4,619,834, which disclosure is incorporated herein by reference, and mixtures thereof;

(b) water-soluble artificial sweeteners such as soluble saccharin salts, i.e., sodium or calcium saccharin salts, cyclamate salts, the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, and mixtures thereof;

(c) dipeptide based sweeteners, such as L-aspartic acid derived sweeteners, such as L-aspartyl-L-phenylalanine methyl ester (Aspartame) and materials described in U.S. Pat. No. 3,492,131, L-alphaaspartyl-N-(2,2,4,4-tetramethyl-3-thietanyl)-D-alaninamide hydrate (Alitame), N-[N-(3,3-dimethylbutyl)-L-aspartyl]-L-phenylalanine 1-methyl ester (Neotame), methyl esters of L-aspartyl-L-phenylglycerine and L-aspartyl-L-2,5-dihydrophenyl-glycine, L-aspartyl-2,5-dihydro-L-phenylalanine; L-aspartyl-L-(I-cyclohexen)-alanine, and mixtures thereof;

(d) water-soluble sweeteners derived from naturally occurring water-soluble sweeteners, such as chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include but are not limited to: 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructo-furanoside, or 4,1′-dichloro-4,1′-dideoxygalactosucrose; 1′,6′-dichloro 1′,6′-dideoxysucrose; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideoxy-beta-D-fructofuranoside, or 4,6,1′,6′-tetrachloro4,6,1′,6′-tetradeoxygalacto-sucrose; and 4,6,1′,6′-tetradeoxy-sucrose, and mixtures thereof;

(e) protein based sweeteners such as thaumatococcus danielli (Thaumatin I and II) and talin;

(f) the sweetener monatin (2-hydroxy-2-(indol-3-ylmethyl)-4-aminoglutaric acid) and its derivatives; and

(g) the sweetener Lo han guo (sometimes also referred to as “Lo han kuo”).

In some embodiments, hydrophobic sweeteners such as those disclosed in U.S. Pat. No. 7,025,999, which disclosure is incorporated herein by reference, and mixtures thereof, may be used. For example, such hydrophobic sweeteners include those of the formulae I-XI as set forth below: 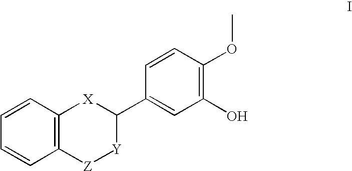
wherein X, Y and Z are selected from the group consisting of CH₂, O and S; 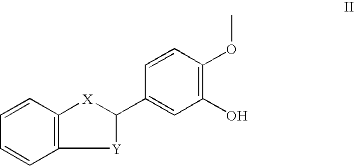
wherein X and Y are selected from the group consisting of S and O; 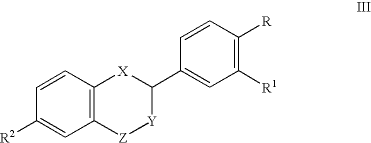
wherein X is S or O; Y is O or CH₂; Z is CH₂, SO₂ or S; R is OCH₃, OH or H; R¹ is SH or OH and R² is H or OH; 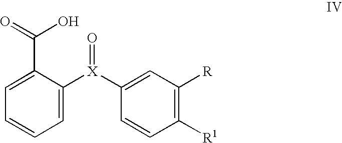
wherein X is C or S; R is OH or H and R¹ is OCH₃ or OH; 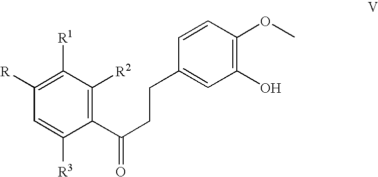
wherein R, R²and R³ are OH or H and R¹ is H or COOH; 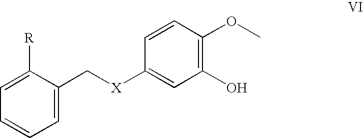
wherein X is O or CH₂ and R is COOH or H; 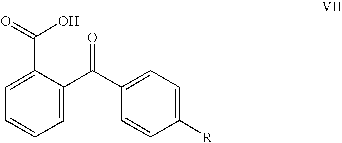
wherein R is CH₃CH₂, OH, N (CH3)₂ or Cl;

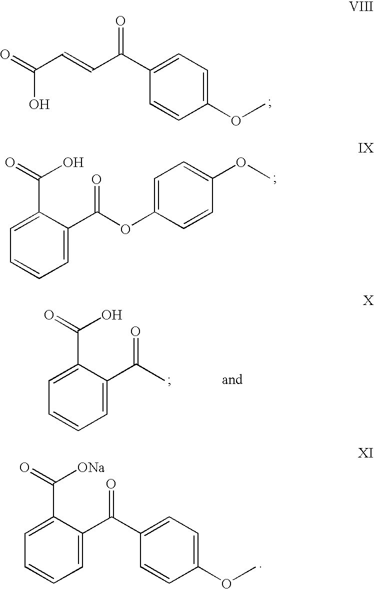

The intense sweetening agents may be used in many distinct physical forms well-known in the art to provide an initial burst of sweetness and/or a prolonged sensation of sweetness. Without being limited thereto, such physical forms include free forms, such as spray dried, powdered, beaded forms, encapsulated forms, and mixtures thereof.

In general, an effective amount of intense sweetener may be utilized to provide the level of sweetness desired, and this amount may vary with the sweetener selected. The intense sweetener may be present in amounts from about 0.001% to about 3%, by weight of the product, depending upon the sweetener or combination of sweeteners used. The exact range of amounts for each type of sweetener may be selected by those skilled in the art.

In some embodiments, examples of suitable potentiators, also known as taste potentiators include, but are not limited to, neohesperidin dihydrochalcone, chlorogenic acid, alapyridaine, cynarin, miraculin, glupyridaine, pyridinium-betain compounds, glutamates, such as monosodium glutamate and monopotassium glutamate, neotame, thaumatin, tagatose, trehalose, salts, such as sodium chloride, monoammonium glycyrrhizinate, vanilla extract (in ethyl alcohol), sugar acids, potassium chloride, sodium acid sulfate, hydrolyzed vegetable proteins, hydrolyzed animal proteins, yeast extracts, adenosine monophosphate (AMP), glutathione, nucleotides, such as inosine monophosphate, disodium inosinate, xanthosine monophosphate, guanylate monophosphate, alapyridaine (N-(1-carboxyethyl)-6-(hydroxymethyl)pyridinium-3-ol inner salt, sugar beet extract (alcoholic extract), sugarcane leaf essence (alcoholic extract), curculin, strogin, mabinlin, gymnemic acid, 3-hydrobenzoic acid, 2,4-dihydrobenzoic acid, citrus aurantium, vanilla oleoresin, sugarcane leaf essence, maltol, ethyl maltol, vanillin, licorice glycyrrhizinates, compounds that respond to G-protein coupled receptors (T2Rs and T1Rs) and taste potentiator compositions that impart kokumi, as disclosed in U.S. Pat. No. 5,679,397 to Kuroda et al., which is incorporated in its entirety herein by reference. “Kokumi” refers to materials that impart “mouthfulness” and “good body”.

Sweetener potentiators, which are a type of taste potentiator, enhance the taste of sweetness. In some embodiments, exemplary sweetener potentiators include, but are not limited to, monoammonium glycyrrhizinate, licorice glycyrrhizinates, citrus aurantium, alapyridaine, alapyridaine (N-(1-carboxyethyl)-6-(hydroxymethyl)pyridinium-3-ol) inner salt, miraculin, curculin, strogin, mabinlin, gymnemic acid, cynarin, glupyridaine, pyridinium-betain compounds, sugar beet extract, neotame, thaumatin, neohesperidin dihydrochalcone, tagatose, trehalose, maltol, ethyl maltol, vanilla extract, vanilla oleoresin, vanillin, sugar beet extract (alcoholic extract), sugarcane leaf essence (alcoholic extract), compounds that respond to G-protein coupled receptors (T2Rs and T1Rs) and combinations thereof

Additional examples of potentiators for the enhancement of salt taste include acidic peptides, such as those disclosed in U.S. Pat. No. 6,974,597, herein incorporated by reference. Acidic peptides include peptides having a larger number of acidic amino acids, such as aspartic acid and glutamic acid, than basic amino acids, such as lysine, arginine and histidine. The acidic peptides are obtained by peptide synthesis or by subjecting proteins to hydrolysis using endopeptidase, and if necessary, to deamidation. Suitable proteins for use in the production of the acidic peptides or the peptides obtained by subjecting a protein to hydrolysis and deamidation include plant proteins, (e.g. wheat gluten, corn protein (e.g., zein and gluten meal), soybean protein isolate), animal proteins (e.g., milk proteins such as milk casein and milk whey protein, muscle proteins such as meat protein and fish meat protein, egg white protein and collagen), and microbial proteins (e.g., microbial cell protein and polypeptides produced by microorganisms).

The chewable confectionery product also may include sensates in the coating and/or the core of the product. Sensates may include warming, cooling and tingling agents. Sensates may be present in amounts of about 0.001% to about 1.5% by weight of the product. In some embodiments, sensates may be present in amounts of about 0.03% to about 0.2% by weight.

Compounds that provide a cooling sensation may include physiological cooling agents. A variety of well known cooling agents may be employed. For example, among the useful cooling agents are included xylitol, erythritol, dextrose, sorbitol, menthane, menthone, ketals, menthone ketals, menthone glycerol ketals, substituted p-menthanes, acyclic carboxamides, mono menthyl glutarate, substituted cyclohexanamides, substituted cyclohexane carboxamides, substituted ureas and sulfonamides, substituted menthanols, hydroxymethyl and hydroxymnethyl derivatives of p-menthane, 2-mercapto-cyclo-decanone, hydroxycarboxylic acids with 2-6 carbon atoms, cyclohexanamides, menthyl acetate, menthyl salicylate, N,2,3-trimethyl-2-isopropyl butanamide (WS-23), N-ethyl-p-menthane-3-carboxamide (WS-3), isopulegol, 3-(1-menthoxy)propane-1,2-diol, 3-(1-menthoxy)-2-methylpropane-1,2-diol, p-menthane-2,3-diol, p-menthane-3,8-diol, 6-isopropyl-9-methyl-1,4-dioxaspiro[4,5]decane-2-methanol, menthyl succinate and its alkaline earth metal salts, trimethylcyclohexanol, N-ethyl-2-isopropyl-5-methylcyclohexanecarboxamide, Japanese mint oil, peppermint oil, 3-(1-menthoxy)ethan-1-ol, 3-(1-menthoxy)propan-1-ol, 3-(1-menthoxy)butan-1-ol, 1-menthylacetic acid N-ethylamide, 1-menthyl-4-hydroxypentanoate, 1-menthyl-3-hydroxybutyrate, N,2,3-trimethyl-2-(1-methylethyl)-butanamide, n-ethyl-t-2-c-6 nonadienamide, N,N-dimethyl menthyl succinamide, substituted p-menthanes, substituted p-menthane-carboxamides, 2-isopropanyl-5-methylcyclohexanol (from Hisamitsu Pharmaceuticals, hereinafter “isopregol”); menthone glycerol ketals (FEMA 3807, trade name FRESCOLAT® type MGA); 3-1-menthoxypropane-1,2-diol (from Takasago, FEMA 3784); and menthyl lactate; (from Haarman & Reimer, FEMA 3748, trade name FRESCOLAT® type ML), WS-30, WS-14, Eucalyptus extract (p-Mehtha-3,8-Diol), Menthol (its natural or synthetic derivatives), Menthol PG carbonate, Menthol EG carbonate, Menthol glyceryl ether, N-tertbutyl-p-menthane-3-carboxamide, P-menthane-3-carboxylic acid glycerol ester, Methyl-2-isopryl-bicyclo (2.2.1), Heptane-2-carboxamide; and Menthol methyl ether, and menthyl pyrrolidone carboxylate among others. These and other suitable cooling agents are further described in the following U.S. patents, all of which are incorporated in their entirety by reference hereto: U.S. Pat. Nos. 4,230,688; 4,032,661; 4,459,425; 4,136,163; 5,266,592; 6,627,233.

Warming agents may be selected from a wide variety of compounds known to provide the sensory signal of warming to the individual user. These compounds offer the perceived sensation of warmth, particularly in the oral cavity, and often enhance the perception of flavors, sweeteners and other organoleptic components. Useful warming agents include those having at least one allyl vinyl component, which may bind to oral receptors. Examples of suitable warming agents include, but are not limited to: vanillyl alcohol n-butylether (TK-1000, supplied by Takasago Perfumery Company Ltd., Tokyo, Japan); vanillyl alcohol n-propylether; vanillyl alcohol isopropylether; vanillyl alcohol isobutylether; vanillyl alcohol n-aminoether; vanillyl alcohol isoamylether; vanillyl alcohol n-hexylether; vanillyl alcohol methylether; vanillyl alcohol ethylether; gingerol; shogaol; paradol; zingerone; capsaicin; dihydrocapsaicin; nordihydrocapsaicin; homocapsaicin; homodihydrocapsaicin; ethanol; isopropyl alcohol; iso-amylalcohol; benzyl alcohol; glycerine; chloroform; eugenol; cinnamon oil; cinnamic aldehyde; phosphate derivatives thereof; and combinations thereof.

Tingling agents may provide a tingling, stinging or numbing sensation to the user. Tingling agents include, but are not limited to: Jambu Oleoresin or para cress (Spilanthes sp.), in which the active ingredient is Spilanthol; Japanese pepper extract (Zanthoxylum peperitum), including the ingredients known as Saanshool-I, Saanshool-II and Sanshoamide; black pepper extract (piper nigrum), including the active ingredients chavicine and piperine; Echinacea extract; Northern Prickly Ash extract; and red pepper oleoresin. Tingling agents are described in U.S. Pat. No. 6,780,443 to Nakatsu et al., U.S. Pat. No. 5,407,665 to McLaughlin et al., U.S. Pat. No. 6,159,509 to Johnson et al. and U.S. Pat. No. 5,545,424 to Nakatsu et al., each of which is incorporated by reference herein in its entirety.

In some embodiments, the confectionery product also may include oral care actives in the coating and/or the core of the product. Oral care actives which may be used include those actives known to the skilled artisan, such as, but not limited to, surfactants, breath freshening agents, anti-microbial agents, antibacterial agents, anti-calculus agents, anti-plaque agents, oral malodor control agents, fluoride compounds, quaternary ammonium compounds and combinations thereof.

Suitable surfactants include, but are not limited to, salts of fatty acids selected from the group consisting of C₈-C₂₄, palmitoleic acid, oleic acid, eleosteric acid, butyric acid, caproic acid, caprylic acid, capric acid, lauric acid, myristic acid, palmitic acid, stearic acid, ricinoleic acid, arachidic acid, behenic acid, lignoceric acid, cerotic acid, sulfated butyl oleate, medium and long chain fatty acid esters, sodium oleate, salts of fumaric acid, potassium glomate, organic acid esters of mono- and diglycerides, stearyl monoglyceridyl citrate, succistearin, dioctyl sodium sulfosuccinate, glycerol tristearate, lecithin, hydroxylated lecithin, sodium lauryl sulfate, acetylated monoglycerides, succinylated monoglycerides, monoglyceride citrate, ethoxylated mono- and diglycerides, sorbitan monostearate, calcium stearyl-2-lactylate, sodium stearyl lactylate, lactylated fatty acid esters of glycerol and propylene glycerol, glycerol-lactoesters of C₈-C₂₄ fatty acids, polyglycerol esters of C₈-C₂₄ fatty acids, propylene glycol alginate, sucrose C₈-C₂₄ fatty acid esters, diacetyl tartaric and citric acid esters of mono- and diglycerides, triacetin, sarcosinate surfactants, isethionate surfactants, tautate surfactants, pluronics, polyethylene oxide condensates of alkyl phenols, products derived from the condensation of ethylene oxide with the reaction product of propylene oxide and ethylene diamine, ethylene oxide condensates of aliphatic alcohols, long chain tertiary amine oxides, long chain tertiary phosphine oxides, long chain dialkyl sulfoxides, and combinations thereof.

Suitable antibacterial agents include, but are not limited to, chlorhexidine, alexidine, quaternary ammonium salts, benzethonium chloride, cetyl pyridinium chloride, 2,4,4′-trichloro-2′-hydroxy-diphenyl ether (triclosan) and combinations thereof.

Suitable fluoride compounds include, but are not limited to, sodium fluoride, sodium monofluorophosphate, stannous fluoride and combinations thereof.

Suitable anti-calculus agents include, but are not limited to, pyrophosphates, triphosphates, polyphosphates, polyphosphonates, dialkali metal pyrophosphate salt, tetra alkali polyphosphate salt, tetrasodium pyrophosphate, tetrapotassium pyrophosphate, sodium tripolyphosphate and combinations thereof.

Suitable anti-microbial agents include, but are not limited to, cetylpyridinium chloride, zinc compounds, copper compounds and combinations thereof.

Other oral care actives known to those skilled in the art are considered well within the scope of the present invention.

Some embodiments also may include a lubricant in the core of the confectionery product. Lubricants may assist in processing the confectionery composition into pressed tablets. More specifically, lubricants conventionally are used to prevent excess wear on dies and punches in tableting manufacture. Lubricants may be useful immediately after compression of the tablet within the die to reduce friction between the tablet and inner die wall.

The lubricant may be added separately or it may be included with the bulk sweetener, as in some commercially available tableting powders. Examples of suitable lubricants include: metallic stearates, particularly magnesium stearate; fatty acids; hydrogenated vegetable oil; partially hydrogenated vegetable oils; animal fats; polyethylene glycols; polyoxyethylene monostearate; talc; silicon dioxide; and combinations thereof. Lubricants may be present in amounts of about 0.1% to about 5% by weight of the core.

In some embodiments, other materials may be added to the coating to achieve desired properties. These materials may include without limitations, cellulosics such as carboxymethyl cellulose, gelatin, xanthan gum, gum arabic and polyvinyl alcohol (PVA).

The coating also may include a pre-coating, which may be added to the individual cores prior to the coating. The pre-coating may include an application of polyvinyl alcohol (PVA). This may be applied as a solution of PVA in a solvent, such as ethyl alcohol. The PVA application may be approximately 3% to 4% by weight of the total coating or about 1% of the total weight of the confectionery product (including a tablet core and coating).

A variety of traditional ingredients also may be included in the coating and/or core of the confectionery products in effective amounts such as coloring agents, antioxidants, preservatives, and the like. Coloring agents may be used in amounts effective to produce the desired color. The coloring agents may include pigments which may be incorporated in amounts up to about 10%, by weight of the composition. For example, titanium dioxide may be incorporated in amounts up to about 8%, and preferably less than about 5%, by weight of the composition. The colorants may also include natural food colors and dyes suitable for food, drug and cosmetic applications. These colorants are known as F.D.& C. dyes and lakes. The materials acceptable for the foregoing uses are preferably water-soluble. Illustrative nonlimiting examples include the indigoid dye known as F.D.& C. Blue No. 2, which is the disodium salt of 5,5-indigotindisulfonic acid. Similarly, the dye known as F.D.& C. Green No. 1 comprises a triphenylmethane dye and is the monosodium salt of 4-[4-(N-ethyl-p-sulfoniumbenzylamino)diphenylmethylene]-[1-(N-ethyl-N-p-sulfoniumbenzyl)-delta-2,5-cyclohexadieneimine]. A full recitation of all F.D.& C. colorants and their corresponding chemical structures may be found in the Kirk-Othmer Encyclopedia of Chemical Technology, 3rd Edition, in volume 5 at pages 857-884, which text is incorporated herein by reference.

The pressed tablet then may be coated with a coating which may include a sugarless bulk sweetener and/or a bulk sugar sweetener, an intense sweetener, a first flavor and a lubricant, each as described above. The coating may include a sugarless bulk sweetener, an intense sweetener, a coloring agent and a second flavor, which is different from the first flavor, each as described above. The coating may also contain a third flavor. The first, second and third flavors may be different from one another and may be selected from fruit, cinnamon and mint flavors.

Methods of Preparing and Using Chewable Confectionery Products

Some embodiments are directed to methods of preparing confectionery products, particularly pressed tablets surrounded by a coating. In accordance with such methods, a particulate bulk sweetener is provided. The particulate bulk sweetener may be in the form of a powder. The particulate bulk sweetener may be mixed with a first, or core, flavor. It may be desirable to mix the particulate bulk sweetener and flavor until a homogenous mix is achieved. A homogenous mixture may provide a pressed tablet of similar homogenous make-up. Conventional mixing apparatus known to those skilled in the art may be used.

Additional components, such as intense sweeteners, sensates, oral care actives, and coloring agents, among others, also may be added. Once the components are blended in, the mixture may be passed through a screen of desired mesh size. Other components, such as lubricants, may be added and the batch may be further mixed. It may be desirable to mix until the batch is a homogenous powder. The batch then may be punched or pressed into tablets on a conventional tableting machine, such as a single stroke tablet press or a multi-head, rotary type tablet press.

The pressed tablet then may be coated with a coating, as described above. The coating may be applied in a conventional manner by successive applications of a coating solution, with drying in between each coat. In some embodiments, the tablet cores may be placed into a standard batch coating mixer. The coating material may be heated to about 70-100° C. before application. The coating material may be sprayed onto the cores as they are tumbled and rotated in the mixer. Conditioned air may be circulated or forced into the mixer to dry each of the successive coating layers on the formed products. Multiple layers of the coating material may be applied on the cores in this manner to form a coating thereon. As the coating dries it usually becomes opaque and is usually white, though other colorants may be added. A coating can be further coated with a polishing agent, such as wax. The coating can further include colored flakes or speckles.

The coating material may be applied to the cores by any method known in the art including the method described above.

Some embodiments are directed to methods of providing a sequential flavor release in the oral cavity of an individual. In accordance therewith, a confectionery product, as described above, is provided. The confectionery product may be applied into the oral cavity of the individual. As the individual consumes the product, the coating dissolves and releases the coating flavor or flavors into the oral cavity. The individual then consumes the core of the product, thereby sequentially releasing the different core flavor into the oral cavity of the individual.

The features and advantages of the present invention are more fully shown by the following examples which are provided for purposes of illustration, and are not to be construed as limiting the invention in any way.

### EXAMPLES

TABLE 1
Tablet Core Compositions

| Component | Example 1 | | Example 2 | | Example 3 | | Example 4 | |
|---|---|---|---|---|---|---|---|---|
| Compressible Sugar(s) | 85%-99% | w/w | | | 85%-99% | w/w | | |
| Compressible Polyol(s) | | | 85%-99% | w/w | | | 85%-99% | w/w |
| Liquid Flavor | 0.05%-1.5% | w/w | 0.05%-1.5% | w/w | 0.05%-1.5% | w/w | 0.05%-1.5% | w/w |
| Dry Flavor | 0.1%-10.0% | w/w | 0.1%-10.0% | w/w | 0.1%-10.0% | w/w | 0.1%-10.0% | w/w |
| Active Ingredient | 0.05%-1.2% | w/w | 0.05%-1.2% | w/w | 0.05%-1.2% | w/w | 0.05%-1.2% | w/w |
| Magnesium Stearate | 0.1%-2.0% | w/w | 0.1%-2.0% | w/w | 0.1%-2.0% | w/w | 0.1%-2.0% | w/w |
| High Intensity Sweetener | 0.0001%-3.0% | w/w | | | | | 0.0001%-3.0% | w/w |

TABLE 2
Tablet Coating Compositions

| Component | Example 10 | | Example 20 | | Example 30 | | Example 40 | |
|---|---|---|---|---|---|---|---|---|
| Sugar(s) | 50%-75% | w/w | | | 50%-75% | w/w | | |
| Polyol(s) | | | 50%-75% | w/w | | | 50%-75% | w/w |
| Colorant(s) | 0.1%-5.0% | w/w | 0.1%-5.0% | w/w | 0.1%-5.0% | w/w | 0.1%-5.0% | w/w |
| Acid(s) | 0.5%-5.0% | w/w | | | | | 0.5%-5.0% | w/w |
| Gum Arabic | 0.5%-10.0% | w/w | 0.5%-10.0% | w/w | 0.5%-10.0% | w/w | 0.5%-10.0% | w/w |
| High Intensity | 0.0001%-3.0% | w/w | 0.0001%-3.0% | w/w | | | | |
| Sweetener | | | | | | | | |

| | | | | |
|---|---|---|---|---|
| Water | q.s. | q.s. | q.s. | q.s. |

A sugared pressed tablet core is prepared according to the formulations in Table 1 above.

The sugar(s) and/or the polyol(s) are blended together with the remaining ingredients in a suitable mixer such as a blender and mixed until homogeneous and a desirable powdered consistency is achieved. The batch is then fed into the compression apparatus and compressed into tablet cores.

The pressed tablet cores then are coated to provide a coating thereon. The cores are transferred into a standard batch coating pan. In a separate mixing vessel, the coating solution is prepared by mixing together the ingredients as shown in Table 2 above and warming the solution to 70° C. to 100° C. In other embodiments, the solution may be warmed to a temperature of about 80° C. to about 90° C. The pan is set to rotate while the coating solution is added to the mixer as the cores rotate therein. Air is introduced into the mixer until the product is dry. Multiple layers may be applied in this manner until a desired amount is applied.

Once a desired amount of coating is applied, a first portion of liquid flavor is added to the mixer. Subsequently, a second portion of the same or different liquid flavor may be added. The liquid flavor(s) may be different from the flavor contained in the pressed tablet cores. Additionally, flavor(s), acid(s), and/or colorant(s) may be added as dry charges which are applied to the exterior of the confection in between applications of coating solution.

The texture of the coating can be manipulating by manipulating the extent of drying for the layers. More complete drying can result in a harder and crunchier/crispier coating. Less complete drying can result in a softer, less crunchy coating.

Subsequently, the entire batch of coated cores may be transferred to a polishing pan. Wax can be added to the polishing pan and applied to the cores for about 20-30 minutes.

The final coated confection can weigh about 0.20 g per individual piece (0.10 g coating and 0.1 g core). The tablet core can have a hardness of at least about 25 KPU.

1. A chewable confectionery product comprising:
(a) a dissolvable tablet core comprising a first flavor; and
(b) a coating surrounding said tablet core, said coating comprising a second flavor, wherein said first flavor is different from said second flavor.

2. The product of claim 1, wherein said core comprises a tablet selected from the group consisting of a pressed tablet, an extruded tablet, a molded tablet and combinations thereof.

3. The product of claim 1, wherein said core comprises at least one bulk sweetener.

4. The product of claim 3, wherein said bulk sweetener is particulate.

5. The product of claim 3, wherein said bulk sweetener comprises a sugar sweetener selected from the group consisting of sucrose, dextrose, maltose, dextrin, xylose, ribose, glucose, mannose, galactose, fructose, invert sugar, fructo oligo saccharide syrups, partially hydrolyzed starch, corn syrup solids and mixtures thereof.

6. The product of claim 3, wherein said bulk sweetener comprises a sugarless bulk sweetener selected from the group consisting of sorbitol, xylitol, mannitol, galactitol, maltitol, hydrogenated isomaltulose, lactitol, erythritol, hydrogenated starch hydrolysate, stevia and mixtures thereof.

7. The product of claim 3, wherein said bulk sweetener comprises a combination of a sugar sweetener selected from the group consisting of sucrose, dextrose, maltose, dextrin, xylose, ribose, glucose, mannose, galactose, fructose, invert sugar, fructo oligo saccharide syrups, partially hydrolyzed starch, corn syrup solids and mixtures thereof and a sugarless bulk sweetener selected from the group consisting of sorbitol, xylitol, mannitol, galactitol, maltitol, hydrogenated isomaltulose, lactitol, erythritol, hydrogenated starch hydrolysate, stevia and mixtures thereof.

8. The product of claim 1, wherein said coating comprises at least one bulk sweetener.

9. The product of claim 8 wherein said bulk sweetener comprises a sugar sweetener selected from the group consisting of sucrose, dextrose, maltose, dextrin, xylose, ribose, glucose, mannose, galactose, fructose, invert sugar, fructo oligo saccharide syrups, partially hydrolyzed starch, corn syrup solids and mixtures thereof.

10. The product of claim 8 wherein said bulk sweetener comprises a sugarless bulk sweetener selected from the group consisting of sorbitol, xylitol, mannitol, galactitol, maltitol, hydrogenated isomaltulose, lactitol, erythritol, hydrogenated starch hydrolysate, stevia and mixtures thereof.

11. The product of claim 8 wherein said bulk sweetener comprises a hybrid combination of a sugar sweetener and a sugarless bulk sweetener.

12. The product of claim 1, wherein said core comprises a sugar sweetener and said coating comprises a sugarless bulk sweetener.

13. The product of claim 1, wherein said core comprises a food-grade acid and said coating comprises a food-grade acid.

14. The product of claim 1, wherein said core comprises a food-grade acid and said coating comprises a sugarless bulk sweetener.

15. The product of claim 1, wherein said core comprises a food-grade acid and said coating comprises a sugar sweetener.

16. The product of claim 1, wherein said core comprises a sugar sweetener and said coating comprises a food-grade acid.

17. The product of claim 1, wherein said core comprises a sugarless bulk sweetener and said coating comprises a food-grade acid.

18. The product of claim 1, wherein said core comprises a sugarless bulk sweetener and said coating comprises a sugar sweetener.

19. The product of claim 1, wherein said core comprises a first sugar sweetener and said coating comprises a second sugar sweetener, said first and said second sugar sweeteners being the same or different.

20. The product of claim 1, wherein said core comprises a first sugarless bulk sweetener and said coating comprises a second sugarless bulk sweetener, said first and said second sugarless bulk sweeteners being the same or different.

21. The product of claim 1, wherein said first flavor is selected from the group consisting of flavor oils; flavoring aromatics and/or oils; oleoresins; extracts derived from plants, leaves, flowers or fruits; derivatives and combinations thereof.

22. The product of claim 1, wherein said first flavor is selected from the group consisting of spearmint oil; cinnamon oil; oil of wintergreen; peppermint oil; clove oil; bay oil; anise oil; eucalyptus oil; thyme oil; cedar leaf oil; oil of nutmeg; allspice; oil of sage; mace; oil of bitter almonds; cassia oil; vanilla; lemon; orange; lime; grapefruit; apple; pear; peach; grape; strawberry; raspberry; cherry; plum; pineapple; apricot; menthol; cinnamon derivatives; cinnamyl acetate; cinnamaldehyde; citral diethylacetal; dihydrocarvyl acetate; eugenyl formate; p-methylamisol; acetaldehyde; benzaldehyde; anisic aldehyde; cinnamic aldehyde; alpha-citral; beta-citral; decanal; ethyl vanillin; piperonal; vanillin; alpha-amyl cinnamaldehyde; butyraldehyde; valeraldehyde; citronellal; aldehyde C-8; aldehyde C-9; aldehyde C-12; 2-ethyl butyraldehyde; trans-2; tolyl aldehyde; veratraldehyde; 2,6-dimethyl-5-heptenal; 2,6-dimethyloctanal; 2-dodecenal; strawberry shortcake; and combinations thereof.

23. The product of claim 1, wherein said second flavor is selected from the group consisting of flavor oils; flavoring aromatics and/or oils; oleoresins; extracts derived from plants, leaves, flowers or fruits; derivatives and combinations thereof.

24. The product of claim 1, wherein said second flavor is selected from the group consisting of spearmint oil; cinnamon oil; oil of wintergreen; peppermint oil; clove oil; bay oil; anise oil; eucalyptus oil; thyme oil; cedar leaf oil; oil of nutmeg; allspice; oil of sage; mace; oil of bitter almonds; cassia oil; vanilla; lemon; orange; lime; grapefruit; apple; pear; peach; grape; strawberry; raspberry; cherry; plum; pineapple; apricot; menthol; cinnamon derivatives; cinnamyl acetate; cinnamaldehyde; citral diethylacetal; dihydrocarvyl acetate; eugenyl formate; p-methylamisol; acetaldehyde; benzaldehyde; anisic aldehyde; cinnamic aldehyde; alpha-citral; beta-citral; decanal; ethyl vanillin; piperonal; vanillin; alpha-amyl cinnamaldehyde; butyraldehyde; valeraldehyde; citronellal; aldehyde C-8; aldehyde C-9; aldehyde C-12; 2-ethyl butyraldehyde; trans-2; tolyl aldehyde; veratraldehyde; 2,6-dimethyl-5-heptenal; 2,6-dimethyloctanal; 2-dodecenal; strawberry shortcake; and combinations thereof.

25. The product of claim 1, wherein said first flavor comprises a fruit flavor and said second flavor comprises a mint flavor.

26. The product of claim 1, wherein said first flavor comprises a mint flavor and said second flavor comprises a fruit flavor.

27. The product of claim 1, wherein said core further comprises a sensate selected from the group consisting of cooling agents, warming agents, tingling agents and combinations thereof.

28. The product of claim 1, wherein said first flavor is a dominant flavor as compared to said second flavor.

29. The product of claim 1, wherein said second flavor is a dominant flavor as compared to said first flavor.

30. The product of claim 1, wherein said first and said second flavors combine in the mouth to provide an enhanced perception of flavor extension of one or both of said flavors.

31. The product of claim 1, wherein the initial flavor impact is one of said first flavor, said second flavor or a combination of both flavors.

32. The product of claim 1, wherein said coating further comprises a sensate selected from the group consisting of cooling agents, warming agents, tingling agents and combinations thereof.

33. The product of claim 1, wherein said core further comprises an oral care active selected from the group consisting of surfactants; breath freshening agents; anti-microbial agents; antibacterial agents; anti-calculus agents; anti-plaque agents; oral malodor control agents; fluoride compounds; quaternary ammonium compounds; and combinations thereof.

34. The product of claim 1, wherein said coating further comprises an oral care active selected from the group consisting of surfactants; breath freshening agents; anti-microbial agents; antibacterial agents; anti-calculus agents; anti-plaque agents; oral malodor control agents; fluoride compounds; quaternary ammonium compounds; and combinations thereof.

35. The product of claim 1, wherein said coating comprises about 25% to about 85% by weight of said product.

36. The product of claim 1, wherein said coating comprises about 5% to about 95% by weight of said product.

37. The product of claim 1, wherein said core comprises about 15% to about 75% by weight of said product.

38. The product of claim 1, wherein said core comprises about 5% to about 95% by weight of said product.

39. The product of claim 1, wherein said core has a hardness of at least about 10 KPU.

40. The product of claim 1, wherein said core has a moisture content of less than about 1%.

41. The product of claim 1, wherein said product has a weight of about 0.2 g to about 6 g.

42. A chewable confectionery product comprising:
(a) a dissolvable tablet core comprising a first flavor; and
(b) a coating surrounding said tablet core, said coating comprising a second flavor and a third flavor, wherein said first flavor is different from said second flavor and said third flavor.

43. The product of claim 42, wherein said core comprises a tablet selected from the group consisting of a pressed tablet, an extruded tablet, a molded tablet and combinations thereof.

44. The product of claim 42, wherein said core comprises at least one bulk sweetener.

45. The product of claim 44, wherein said bulk sweetener is particulate.

46. The product of claim 44, wherein said bulk sweetener comprises a sugar sweetener selected from the group consisting of sucrose, dextrose, maltose, dextrin, xylose, ribose, glucose, mannose, galactose, fructose, invert sugar, fructo oligo saccharide syrups, partially hydrolyzed starch, corn syrup solids and mixtures thereof.

47. The product of claim 44, wherein said bulk sweetener comprises a sugarless bulk sweetener selected from the group consisting of sorbitol, xylitol, mannitol, galactitol, maltitol, hydrogenated isomaltulose, lactitol, erythritol, hydrogenated starch hydrolysate, stevia and mixtures thereof.

48. The product of claim 44, wherein said bulk sweetener comprises a combination of a sugar sweetener selected from the group consisting of sucrose, dextrose, maltose, dextrin, xylose, ribose, glucose, mannose, galactose, fructose, invert sugar, fructo oligo saccharide syrups, partially hydrolyzed starch, corn syrup solids and mixtures thereof and a sugarless bulk sweetener selected from the group consisting of sorbitol, xylitol, mannitol, galactitol, maltitol, hydrogenated isomaltulose, lactitol, erythritol, hydrogenated starch hydrolysate, stevia and mixtures thereof.

49. The product of claim 42, wherein said coating comprises at least one bulk sweetener.

50. The product of claim 49, wherein said bulk sweetener comprises a sugar sweetener selected from the group consisting of sucrose, dextrose, maltose, dextrin, xylose, ribose, glucose, mannose, galactose, fructose, invert sugar, fructo oligo saccharide syrups, partially hydrolyzed starch, corn syrup solids and mixtures thereof.

51. The product of claim 49, wherein said bulk sweetener comprises a sugarless bulk sweetener selected from the group consisting of sorbitol, xylitol, mannitol, galactitol, maltitol, hydrogenated isomaltulose, lactitol, erythritol, hydrogenated starch hydrolysate, stevia and mixtures thereof.

52. The product of claim 49, wherein said bulk sweetener comprises a hybrid combination of a sugar sweetener selected and a sugarless bulk sweetener.

53. The product of claim 42, wherein said core comprises a food-grade acid and said coating comprises a food-grade acid.

54. The product of claim 42, wherein said core comprises a food-grade acid and said coating comprises a sugarless bulk sweetener.

55. The product of claim 42, wherein said core comprises a food-grade acid and said coating comprises a sugar sweetener.

56. The product of claim 42, wherein said core comprises a sugar sweetener and said coating comprises a food-grade acid.

57. The product of claim 42, wherein said core comprises a sugarless bulk sweetener and said coating comprises a food-grade acid.

58. The product of claim 42, wherein said core comprises a sugarless bulk sweetener and said coating comprises a sugar sweetener.

59. The product of claim 42, wherein said core comprises a first sugar sweetener and said coating comprises a second sugar sweetener, said first and said second sugar sweeteners being the same or different.

60. The product of claim 42, wherein said core comprises a first sugarless bulk sweetener and said coating comprises a second sugarless bulk sweetener, said first and said second sugarless bulk sweeteners being the same or different.

61. The product of claim 42, wherein said first flavor is selected from the group consisting of flavor oils; flavoring aromatics and/or oils; oleoresins; extracts derived from plants, leaves, flowers or fruits; derivatives and combinations thereof.

62. The product of claim 42, wherein said first flavor is selected from the group consisting of spearmint oil; cinnamon oil; oil of wintergreen; peppermint oil; clove oil; bay oil; anise oil; eucalyptus oil; thyme oil; cedar leaf oil; oil of nutmeg; allspice; oil of sage; mace; oil of bitter almonds; cassia oil; vanilla; lemon; orange; lime; grapefruit; apple; pear; peach; grape; strawberry; raspberry; cherry; plum; pineapple; apricot; menthol; cinnamon derivatives; cinnamyl acetate; cinnamaldehyde; citral diethylacetal; dihydrocarvyl acetate; eugenyl formate; p-methylamisol; acetaldehyde; benzaldehyde; anisic aldehyde; cinnamic aldehyde; alpha-citral; beta-citral; decanal; ethyl vanillin; piperonal; vanillin; alpha-amyl cinnamaldehyde; butyraldehyde; valeraldehyde; citronellal; aldehyde C-8; aldehyde C-9; aldehyde C-12; 2-ethyl butyraldehyde; trans-2; tolyl aldehyde; veratraldehyde; 2,6-dimethyl-5-heptenal; 2,6-dimethyloctanal; 2-dodecenal; strawberry shortcake; and combinations thereof.

63. The product of claim 42, wherein said second flavor is selected from the group consisting of flavor oils; flavoring aromatics and/or oils; oleoresins; extracts derived from plants, leaves, flowers or fruits; derivatives and combinations thereof.

64. The product of claim 42, wherein said third flavor is selected from the group consisting of flavor oils; flavoring aromatics and/or oils; oleoresins; extracts derived from plants, leaves, flowers or fruits; derivatives and combinations thereof.

65. The product of claim 42, wherein said second flavor is selected from the group consisting of spearmint oil; cinnamon oil; oil of wintergreen; peppermint oil; clove oil; bay oil; anise oil; eucalyptus oil; thyme oil; cedar leaf oil; oil of nutmeg; allspice; oil of sage; mace; oil of bitter almonds; cassia oil; vanilla; lemon; orange; lime; grapefruit; apple; pear; peach; grape; strawberry; raspberry; cherry; plum; pineapple; apricot; menthol; cinnamon derivatives; cinnamyl acetate; cinnamaldehyde; citral diethylacetal; dihydrocarvyl acetate; eugenyl formate; p-methylamisol; acetaldehyde; benzaldehyde; anisic aldehyde; cinnamic aldehyde; alpha-citral; beta-citral; decanal; ethyl vanillin; piperonal; vanillin; alpha-amyl cinnamaldehyde; butyraldehyde; valeraldehyde; citronellal; aldehyde C-8; aldehyde C-9; aldehyde C-12; 2-ethyl butyraldehyde; trans-2; tolyl aldehyde; veratraldehyde; 2,6-dimethyl-5-heptenal; 2,6-dimethyloctanal; 2-dodecenal; strawberry shortcake; and combinations thereof.

66. The product of claim 42, wherein said third flavor is selected from the group consisting of spearmint oil; cinnamon oil; oil of wintergreen; peppermint oil; clove oil; bay oil; anise oil; eucalyptus oil; thyme oil; cedar leaf oil; oil of nutmeg; allspice; oil of sage; mace; oil of bitter almonds; cassia oil; vanilla; lemon; orange; lime; grapefruit; apple; pear; peach; grape; strawberry; raspberry; cherry; plum; pineapple; apricot; menthol; cinnamon derivatives; cinnamyl acetate; cinnamaldehyde; citral diethylacetal; dihydrocarvyl acetate; eugenyl formate; p-methylamisol; acetaldehyde; benzaldehyde; anisic aldehyde; cinnamic aldehyde; alpha-citral; beta-citral; decanal; ethyl vanillin; piperonal; vanillin; alpha-amyl cinnamaldehyde; butyraldehyde; valeraldehyde; citronellal; aldehyde C-8; aldehyde C-9; aldehyde C-12; 2-ethyl butyraldehyde; trans-2; tolyl aldehyde; veratraldehyde; 2,6-dimethyl-5-heptenal; 2,6-dimethyloctanal; 2-dodecenal; strawberry shortcake; and combinations thereof.

67. The product of claim 42, wherein said first flavor comprises a fruit flavor and said second flavor comprises a mint flavor.

68. The product of claim 42, wherein said first flavor comprises a mint flavor and said second flavor comprises a fruit flavor.

69. The product of claim 42, wherein said core further comprises a sensate selected from the group consisting of cooling agents, warming agents, tingling agents and combinations thereof.

70. The product of claim 42, wherein said first flavor is a dominant flavor as compared to said second flavor.

71. The product of claim 42, wherein said second flavor is a dominant flavor as compared to said first flavor.

72. The product of claim 42, wherein said first and said second flavors combine in the mouth to provide an enhanced perception of flavor extension of one or both of said flavors.

73. The product of claim 42, wherein the initial flavor impact is one of said first flavor, said second flavor or a combination of both flavors.

74. The product of claim 42, wherein said coating further comprises a sensate selected from the group consisting of cooling agents, warming agents, tingling agents and combinations thereof.

75. The product of claim 42, wherein said core further comprises an oral care active selected from the group consisting of surfactants; breath freshening agents; anti-microbial agents; antibacterial agents; anti-calculus agents; anti-plaque agents; oral malodor control agents; fluoride compounds; quaternary ammonium compounds; and combinations thereof.

76. The product of claim 42, wherein said coating further comprises an oral care active selected from the group consisting of surfactants; breath freshening agents; anti-microbial agents; antibacterial agents; anti-calculus agents; anti-plaque agents; oral malodor control agents; fluoride compounds; quaternary ammonium compounds; and combinations thereof.

77. The product of claim 42, wherein said coating comprises about 5% to about 95% by weight of said product.

78. The product of claim 42, wherein said coating comprises about 25% to about 85% by weight of said product.

79. The product of claim 42, wherein said core comprises about 5% to about 95% by weight of said product.

80. The product of claim 42, wherein said core comprises about 15% to about 75% by weight of said product.

81. The product of claim 42, wherein said core has a hardness of at least about 10 KPU.

82. The product of claim 42, wherein said core has a moisture content of less than about 1%.

83. The product of claim 42, wherein said product has a weight of about 0.2 g to about 6 g.

84-165. (canceled)

166. A sequential flavor delivery system comprising:
(a) a dissolvable tablet or chewable candy core, said core comprising:
(i) at least one sugarless bulk sweetener;
(ii) at least one intense sweetener;
(iii) a first flavor selected from the group consisting of fruit, cinnamon and mint flavors; and
(iv) a lubricant; and
(b) a coating surrounding said tablet or candy core, said coating comprising:
(i) at least one sugarless bulk sweetener;
(ii) at least one intense sweetener;
(iii) a coloring agent; and
(iv) a second flavor selected from the group consisting of fruit, cinnamon and mint flavors, wherein said first flavor is different from said second flavor.

167. The delivery system of claim 166, wherein said dissolvable pressed tablet has a moisture content of less than 1%.

168. A confectionery composition comprising:
(a) a substantially water-soluble core comprising a first flavor; and
(b) a confectionery coating substantially enrobing said core, said coating comprising a second flavor.

169. The composition of claim 168, further comprising a third flavor in said coating.

170. The composition of claim 168, wherein said core has a hardness of at least about 10 KPU.

171. The composition of claim 168, wherein said first and said second flavors are from the same flavor category.

172. The composition of claim 169, wherein said first, second and third flavors are from the same flavor category.

173. A method of providing a sequential flavor release in the oral cavity of an individual, comprising the steps of:
(a) providing a confectionery product comprising:
(i) a dissolvable core comprising a first flavor; and
(ii) a coating surrounding the dissolvable core, said coating comprising a second flavor, wherein the first flavor is different from the second flavor;
(b) applying the product into the oral cavity of the individual;
(c) allowing the coating to dissolve and release the second flavor into the oral cavity of the individual; and
(d) allowing the core to dissolve and release the first flavor into the oral cavity of the individual.

174. The method of claim 173, further comprising a third flavor in said coating.

175. A method of preparing a chewable confectionery product, comprising the steps of:
(a) providing a particulate bulk sweetener;
(b) mixing the particulate bulk sweetener with a first flavor;
(c) punching or pressing the mixture to form a tablet core; and
(d) applying one or more layers of a coating material onto the tablet core, wherein the coating material comprises a second flavor, wherein the first flavor is different from the second flavor.

176. The coating of claim 175, further comprising a third flavor.

177. The method of claim 175, wherein the step of mixing the particulate bulk sweetener with a first flavor further comprises mixing until a homogenous mixture is achieved.

178. The method of claim 175, further comprising the step of adding a food-grade lubricant to the mixture.

179. The method of claim 178, wherein the food-grade lubricant is selected from the group consisting of: metallic stearates; fatty acids; hydrogenated vegetable oil; partially hydrogenated vegetable oils; animal fats; polyethylene glycols; polyoxyethylene monostearate; talc; silicon dioxide; and combinations thereof.

180. The method of claim 178, wherein the food-grade lubricant is present in amounts of about 0.1% to about 5% by weight of the tablet core.

181. The method of claim 175, further comprising the step of heating the coating material of step (d) to a temperature of about 80° C. to about 90° C. prior to application onto the tablet core.

182. The method of claim 175, further comprising the step of applying a polishing agent to the coated product.
